(19) United States
(12) Patent Application Publication
(10) Pub. No.: US 2012/0041689 A1
(43) Pub. Date: Feb. 16, 2012

(54) System and method for particle detection in spectral domain

(75) Inventor: Michael Fuhrman, Pittsburgh, PA (US)

(73) Assignee: Chemimage Corporation, Pittsburgh, PA (US)

(21) Appl. No.: 13/317,497

(22) Filed: Oct. 19, 2011

Related U.S. Application Data
(63) Continuation-in-part of application No. 12/684,495, filed on Jan. 8, 2010.
(60) Provisional application No. 61/455,427, filed on Oct. 19, 2010.
(60) Provisional application No. 61/143,562, filed on Jan. 9, 2009.

(51) Int. Cl. G06F 19/00; G01J 3/44

(52) U.S. Cl. 702/28; 356/301

(57) ABSTRACT

The present disclosure provides for a system and method for detecting, sizing, and classifying multiple particles in a sample. A Raman chemical image may be generated representative of a sample. This Raman chemical image may be analyzed to thereby determine at least one geometric property of at least one particle in the sample. Each pixel in the sample may be classified as comprising a particle associated with an active pharmaceutical ingredient of interest. This classification may be achieved by comparing a spectrum associated with each pixel with a reference spectrum. This comparison may be achieved by applying at least one chemometric technique.

### RELATED APPLICATIONS

This Application claims priority under 35 U.S.C. §119(e) to pending U.S. Provisional Application No. 61/455,427, filed on Oct. 15, 2010, entitled “System and Method for Particle Detection in Spectral Domain.” This application is also a continuation-in-part to pending U.S. patent application Ser. No. 12/684,495, filed on Jan. 8, 2010, entitled “Automation of Ingredient-Specific Particle Sizing Employing Raman Chemical Imaging,” which itself claims priority to U.S. Provisional Patent Application No. 61/143,562, filed on Jan. 9, 2009, entitled “Automation of Ingredient-Specific Particle Sizing Employing Raman Chemical Imaging.” The above-reference patent applications are hereby incorporated by reference in their entireties.

### BACKGROUND

Surfaces form the interface between different physical and chemical entities, and the physical and chemical processes that occur at surfaces often control the bulk behavior of materials. For example, the rate of dissolution of drug particles in a biological fluid (e.g., stomach, intestinal, bronchial, or alveolar fluid in a human) can strongly influence the rate of uptake of the drug into an animal. Differences in particle size distribution between two otherwise identical compositions of the same drug can lead to significant differences in the pharmacological properties of the two compositions. Further by way of example, the surface area of a solid chemical catalyst can strongly influence the number and density of sites available for catalyzing a chemical reaction, greatly influencing the properties of the catalyst during the reaction. For these and other reasons, manufacturers often try to closely control particle size and shape. Associations between and among particles can also affect the pharmacological properties of substances in the particles, such as the ability of a substance to dissolve or become active in a biological system.

Numerous methods of analyzing particle sizes and distributions of particle sizes are known in the art, including at least optical and electron microscopy, laser diffraction, physical size exclusion, dynamic light scattering, polarized light scattering, mass spectrometric, sedimentation, focused beam backscattered light reflectance, impedance, radiofrequency migration, Doppler scattering, and other analytical techniques. Each of these techniques has a variety of limitations that preclude its use in certain situations. However, all of these techniques share a critical limitation that prevent effective use of the techniques for a wide variety of samples for which particle analysis would be valuable—namely, none of the prior art techniques is able to distinguish two particles that differ only in chemical composition. Put another way, a first particle having substantially the same size, shape, and weight as a second particle cannot be distinguished from the second particle in these methods.

In addition to distinguishing particles based on chemical composition, it is also useful to determine particle size and particle size distribution (PSD). Particle sizing of Active Pharmaceutical Ingredients (API) and Excipients of Interest implemented using image analysis must be accurate because of the requirements of customers and the Food and Drug Administration (FDA). The FDA acknowledges a critical path opportunity for the development of methodologies for accurate and precise drug particle size measurements in suspension products, thereby minimizing the requirement for in vivo testing.

Batch comparison testing is an important part of product quality studies and is necessary in studying bioavailability (BA) and/or establishing bioequivalence (BE) for products including, but not limited to, nasal sprays. It is recommended by the FDA that in the BA and BE submission that PSD data is submitted for both new drugs (NDAs) and abbreviated new drug applications (ANDAs) for spray and aerosol formulations. Data must be presented prior to and post actuation since this information closely relates to the drug efficacy based on the dissolution rate of the particles. Such information can help establish the potential influence of the device on de-agglomeration.

Optical microscopy is currently the recommended method of assessing and reporting drug and aggregated drug PSD. However, such methodology is subjective and cannot be used with a high degree of confidence for formulated suspensions where drug particle sizing can be easily misjudged due to the presence of insoluble excipients.

Currently, no validated method exists for characterizing API particle size distribution in nasal aerosols and sprays despite the request of such data for BE testing for NDAs and ANDAs. A qualitative and semi-quantitative estimation of drug and aggregated drug PSD is recommended based on optical microscopy, but insoluble suspending agents found in nasal spray formulations typically complicate the ingredient-specific particle size (ISPS) determination. Therefore, there exists a need for an accurate and reliable system and method for performing such analysis on particle samples.

Correct identification of drug particles based on chemistry is essential for the development of better formulations, since the changes in chemical structure of API(s) can affect pharmacological properties of the final product. There exists a need for accurate and reliable systems and methods for the identification and sizing of particles.

Spectroscopic imaging combines digital imaging and molecular spectroscopy techniques, which can include Raman scattering, fluorescence, photoluminescence, ultraviolet, visible, short wave infrared (SWIR), and infrared absorption spectroscopies. When applied to the chemical analysis of materials, spectroscopic imaging is commonly referred to as chemical imaging. Chemical imaging is a reagentless tissue imaging approach based on the interaction of laser light with tissue samples. The approach yields an image of a sample wherein each pixel of the image is the spectrum of the sample at the corresponding location. The spectrum carries information about the local chemical environment of the sample at each location. Instruments for performing spectroscopic (i.e. chemical) imaging typically comprise an illumination source, image gathering optics, focal plane array imaging detectors and imaging spectrometers.

In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over an entire area encompassing the sample simultaneously using an electronically tunable optical imaging filter such as an acousto-optic tunable filter (AOTF), a multi-conjugate tunable filter (MCF), or a liquid crystal tunable filter (LCTF). Here, the organic material in such optical filters are actively aligned by applied voltages to produce the desired bandpass and transmission function. The spectra obtained for each pixel of such an image thereby forms a complex data set referred to as a hyperspectral image which contains the intensity values at numerous wavelengths or the wavelength dependence of each pixel element in this image.

One method for using Raman spectroscopic methods for component particle analysis is described in U.S. Pat. No. 7,379,179 to Nelson et al., entitled “Raman Spectroscopic Methods for Component Particle Analysis”, which is hereby incorporated by reference in its entirety.

By providing a “molecular fingerprint”, Raman spectroscopy has become one of the most powerful analytical tools to study molecular composition, identify polymorphs and pseudopolymorphs and evaluate other physico-chemical properties of micron-sized particles. Ultimately, Raman spectroscopy may provide the basis for predicting and controlling future drug properties. New approaches to ingredient specific particle sizing (ISPS) include Wide-field Raman Chemical Imaging (RCI) or optical microscopy followed by Raman microspectroscopy. Recent advancements such as automatic data collection, imaging data processing and particle size distribution (PSD) generation allow an unsupervised ISPS analysis of a statistically significant population of API particles across all Orally Inhaled and Nasal Drug Products (OINDP).

Because OINDP samples contain sparse particle populations, optical microscopy has been leveraged for rapid particle targeting where the identified particles are further interrogated using Raman spectroscopy for chemical identification. In the marketplace, optical microscopy alone has been demonstrated to classify API particles of OINDP samples on the basis of morphological features for further interrogation; however, the method relies on morphologically unique particles in the sample. This method has been shown to work well for foreign particulate matter measurements, but this may not necessarily be ideal for nasal spray suspensions.

No validated method exists for characterizing the ingredient-specific drug particle size in complex nasal spray suspensions due to the presence of insoluble excipients along with suspended API in the formulation. Accurate knowledge of the API particle size is critical for determining the ultimate dissolution rate in the mucous membrane of the nasal cavity as well as establishing bioequivalence (sameness) between a generic and innovator products. Current methods used for such measurements include Anderson Cascade Impaction (ACI) followed by High Performance Liquid Chromatography (HPLC), laser light scattering and optical microscopy; however, each method lacks the ability to perform ingredient specific particle sizing (ISPS).

There exists a need for a rapid, accurate, and reliable system and method of interrogating pharmaceutical samples.

### SUMMARY

The invention relates generally to the use of Raman spectroscopic methods, including Raman chemical imaging and Raman spectroscopy for analyzing two or more particles present in a sample. More specifically, the present invention provides for detecting, sizing, and classifying multiple particles present in a sample. The present disclosure also provides for the use of multivariate analysis to detect and/or identify these particles.

The invention disclosed herein overcomes the limitations of the prior art by implementing an individual particle based approach to particle analysis, thereby improving the dynamic range of particle analysis (increase the range of particles that can be detected). Such an approach is advantageous because it provides for more accurate detection and determination of the number of particles present in a sample and their sizes.

Raman chemical imaging is a versatile technique that is well suited to the analysis of complex heterogeneous materials. In a typical Raman chemical imaging experiment, a specimen is illuminated with monochromatic light, and the Raman scattered light is filtered by an imaging spectrometer which passes only a single wavelength range. The Raman scattered light may then be used to form an image of the specimen. A spectrum is generated corresponding to millions of spatial locations at the sample surface by tuning an imaging spectrometer over a range of wavelengths and collecting images intermittently. Changing the selected passband (wavelength) of the imaging spectrometer to another appropriate wavelength causes a different material to become visible.

The Raman chemical image is comprised of multiple images, each captured at a different wavelength. Contrast is generated in the images based on the relative amounts of Raman scatter or other optical phenomena, such as luminescence, that is generated by different species located throughout the sample. Since a spectrum is generated for each pixel location, chemometric analysis tools can be applied to the image data to extract pertinent information otherwise missed by ordinary univariate measures. The information contained within this multi-wavelength image cube is transformed into a single image plane for image analysis. Any method known in the art may be used to obtain the single plane image. In one embodiment, this may be achieved by extracting an image plane corresponding to a spectral peak of interest. Another method that may be used in another embodiment, which enhances signal-to-noise, is to sum the intensities of the spectral planes which are unique to particles of interest and from this subtract the average of background planes. Still another method that may be used, in another embodiment, is to perform a multivariate analysis to extract a small set of image(s) with high information content for further image processing. Examples of multivariate analysis include cluster analysis, principal component analysis (PCA), Cosine Correlation Analysis (CCA), Euclidian distance analysis (EDA), multivariate curve resolution (MCR), band t. entropy method (BTEM), Mahalanobis distance (MD), adaptive subspace detector (ASD), multivariate curve resolution (MCR), combinations thereof and others known in the art.

A spatial resolving power of approximately 250 nm may be useful for Raman chemical imaging using visible laser wavelengths. This is almost two orders of magnitude better than infrared imaging which is typically limited to 20 microns due to diffraction. In addition, image definition (based on the total number of imaging pixels) can be very high for Raman chemical imaging because of the use of high pixel density detectors (often one million plus detector elements).

The invention disclosed herein is advantageous over the prior art in several ways. For example, the systems and methods of the present disclosure improve the accuracy of particle size measurements by addressing at least three sources of error in particle size measurements including: (1) the non-uniform excitation illumination across the field of view of each image, (2) the dependency of Raman emission from individual particles on their size, morphology, and individual chemistry, and (3) that the physical process of image capture is subject to degradation by noise.

The prior art includes a method known as field flattening to compensate for non-uniform illumination. Prior art uses methods known as baseline correction and spectral normalization to implement field flattening. Other image analysis methods, include the use of an image of uniform field, morphological filters, frequency domain filters, and polynomial functions can be used to improve field flattening. Improvement of field flattening may allow a particle to be visible above background noise, and can be segmented and labeled as an object for further analysis.

The prior art sets a threshold level above background noise. This threshold is set so that the sizes of the particles detected in the Raman chemical image match the appearance of the sizes of the particles in the corresponding brightfield image. Particles with intensities above this threshold are detected as particles and particle sizes are determined from the detected pixels comprising the particles.

At least two problems are apparent from this process when the results are validated: (1) failure to detect all particles in a sample, and (2) failure to accurately size particles detected. Utilization of a global threshold alone may not be sufficient for accurate detection and size determination of particles. This is because particles with low Raman signals will not be detected and can be missed visually by a human performing validation. Particles may have low Raman signals either because they were situated in regions where the excitation illumination was low compared with the center of the field of view or because they were simply low emission particles.

Lowering the threshold intensity, in an attempt to detect more particles, may result in inaccurate sizing of particles. So, while some particles are correctly sized, the sizes of many particles may be too large or too small. This is because a global threshold will not be the optima threshold for every particle in a sample. This may also result in groups of smaller particles being identified as one larger particle. Reprocessing the image within the neighborhood of each detected particle to recompute the size may show that nearby particles were found to affect the automatically computed local threshold and affect the particle size.

The invention of the present disclosure addresses these issues by considering the particle detection step and the particle sizing step as two separate processes. This ensures more accurate particle sizing and is API specific. First, a low global threshold is set to guarantee the detection of all particles. Because of the noise in the Raman spectra, individual pixels which do not correspond to particles of interest may be inadvertently detected. The size of each detected particle is then determined using a threshold unique to each particle detected by applying the global threshold.

Since particle chemistry is just as important as particle size, the present disclosure also provides for a validation step wherein the chemical spectra of each particle is evaluated after the particle has been sized. This step is necessary because the first step of detecting potential particles is subject to noise and therefore the potential for interference exits. After each particle is sized its spectrum is evaluated. This may be achieved by verifying that a spectrum has been obtained, that the shape and appearance of the spectra is characteristic of a particle of interest, or comparing the spectrum to a reference spectrum of a particle type of interest to determine whether or not there is a match (i.e., API or excipient). Particles that do not share the spectrum of the particle of interest are rejected as not a particle of interest.

The invention of the present disclosure overcomes the limitations of the prior art by providing a rapid, accurate, and reliable system and method that can be used to analyze multiple particles in a sample.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

FIG. 1 is representative of a method of the present disclosure.

FIG. 2 is representative of a method of the present disclosure.

FIG. 3 is representative of a method of the present disclosure.

FIG. 4A is representative of a method of the present disclosure.

FIG. 4B is representative of a method of the present disclosure.

FIG. 5 is illustrative of a system of the present disclosure.

FIGS. 6A-6D are illustrative of the detection capabilities of the present disclosure.

FIGS. 7A-7C are illustrative of the detection capabilities of the present disclosure.

FIGS. 8A-8F are illustrative of the detection capabilities of the present disclosure.

FIG. 9 is illustrative of the detection capabilities of the present disclosure.

### DETAILED DESCRIPTION

The present disclosure provides for a system and method for analyzing particles in a sample. The method disclosed herein is useful for determining geometric properties of particles in a sample. The method also holds potential for evaluating other attributes of particles in a sample during particle analysis.

The patent or application file contains at least one drawing executed in color. Copies of this patent or patent application publication with color drawing(s) will be provided by the Office upon request and payment of the necessary fee.

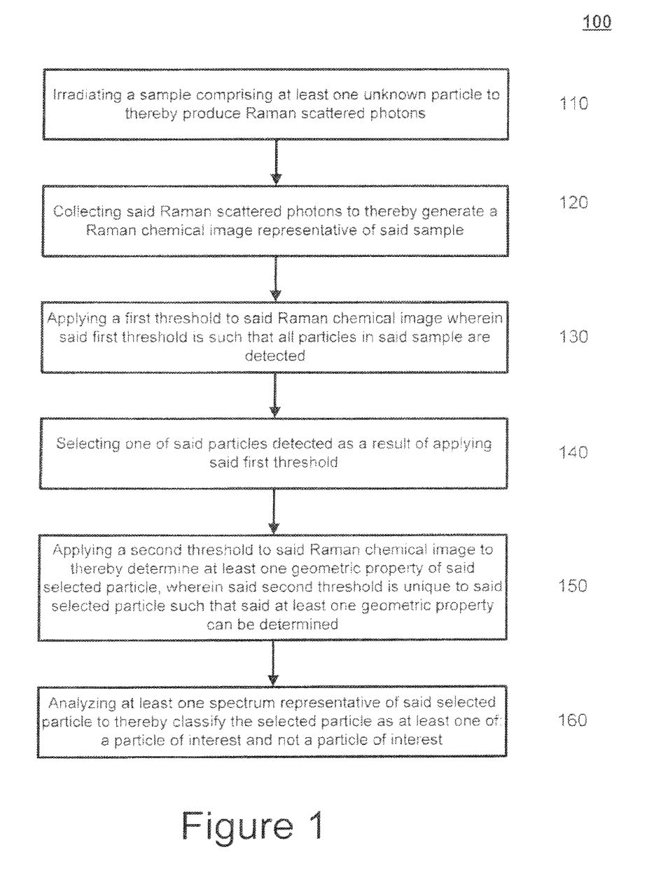

In one embodiment, illustrated by FIG. 1, the method 100 comprises irradiating a sample comprising at least one unknown particle to thereby produce Raman scattered photons in step 110. In step 120, said Raman scattered photons are collected to thereby generate a Raman chemical image representative of said sample. In step 130, a first threshold is applied to said Raman chemical image wherein said first threshold is such that all particles in said sample are detected. One particle of the particles detected as a result of applying the first threshold is selected in step 140. In step 150, a second threshold is applied to said Raman chemical image to thereby determine at least one geometric property of said selected particle, wherein said second threshold is unique to said selected particle such that said at least one geometric property can be determined. At least one spectrum representative of said selected particle is analyzed in step 160 to thereby classify the selected particle as at least one of: a particle of interest and not a particle of interest.

In one embodiment, the sample is irradiated using wide-field illumination. In another embodiment, the sample is irradiated with substantially monochromatic light. In one embodiment, the determination of geometric properties of particles in the sample is achieved using a RCI hypercube. In such an embodiment, the intensity within the spectral peak is integrated at each pixel to create a working image with a higher signal-to-noise ratio than the peak intensity plane alone. In one embodiment, this can also be used as a method of base-line correction. The resulting working image depicts potential API particles as bright regions.

In one embodiment, the global threshold may be such that it is just above the background noise level. In such an embodiment, the background noise level is estimated and a global threshold barely above the background is implemented. In another embodiment, the global threshold may be some order of standard deviations of the noise above the average background intensity. In another embodiment, the global threshold may comprise three standard deviations of the noise above the average background intensity. Although a global threshold may ensure that all particles in a sample are detected (although with inaccurate sizes), there is also the possibility that some noise will be detected. The second threshold and validation steps account for this.

In one embodiment, the second threshold is determined by: individually processing the edges and brightness of each detected particle. The edges may be detected by computing the gradient of the working image to find the pixels where the intensity changes most rapidly. The pixels corresponding to the steepest edges can be identified and the average intensity of the edge pixels computed. This average intensity can then be used as the second threshold. In one embodiment, these steps can be performed for each particle detected in the sample. In another embodiment, the second threshold comprises a fraction of the peak intensity of the selected particle above the background intensity. In another embodiment, this fraction may comprise one half. Whatever method is used to determine the second threshold, it will be a threshold unique to the selected particle so that at least one geometric property can be accurately determined.

In one embodiment, the invention disclosed herein may be automated. This may be achieved via software. In one embodiment, the determination of a second threshold method may be iterative, meaning that the software will continue to apply one or more different particle specific thresholds (“candidate second thresholds”) to a selected particle until a satisfactory result is achieved. A result is satisfactory when the results can be trusted. In one embodiment, this is measured using Rose's Criterion wherein object intensity is five standard deviations above the average background. The software then repeats this method, detecting and measuring the size of each particle until all of the individual particles present in the sample are detected and measured. This adaptive embodiment may provide for a feedback loop in which information received from the application of a second threshold is evaluated to determine whether or not is it satisfactory. If the result is satisfactory, then this threshold may be applied to assess the particle. If the result is not satisfactory, then a different second threshold is applied and evaluated to determine if a satisfactory result is reached. This feedback loop can continue until the satisfactory result is reached.

In one embodiment, the method may be adaptive in that the processing takes place in each local region while continuously adjusting threshold levels until a satisfactory result is achieved. Such adaptive processing may be useful for the situation where a region thought to contain one particle is found to actually contain one or more particle. The adaptive processing may iteratively continue such that if more than one particle is detected a unique and improved threshold is determined for each subsequently detected particle.

It is further contemplated by the present disclosure that the system and method disclosed herein may hold the potential for parallel processing. In such an embodiment, one or more systems may be configured in such a way that allows for more than one particle to be processed simultaneously. This may be achieved through a computer network or other configuration.

Said second threshold is such that at least one geometric property of the selected particle can be determined. This geometric property can be any property that may be of interest in particle analysis. In one embodiment, the geometric property is characteristic of the size of the particle. In another embodiment, the geometric property is characteristic of the particle size distribution. In yet another embodiment, the geometric property can be selected from the group consisting of: an area, a perimeter, a feret diameter, a maximum chord length, a shape factor, an aspect ratio of the particle, other geometric properties known in the art and combinations thereof.

At least one spectrum of said selected particle is analyzed in the validation step. This validation can be achieved in several ways. Implementing this validation step holds potential for reducing the number of false positives (i.e., the number of particles thought to be a particle of interest that are not actually a particle of interest), making assessment of the sample more accurate. In one embodiment, said validation may comprise confirming that a spectrum is in fact obtained from the selected particle. In another embodiment, said validation may comprise confirming the attributes of the spectrum obtained from the selected particle. This may mean that the spectrum looks like one would expect a spectrum is characteristic of the particle of interest (i.e., does it have a proper shape). In yet another embodiment, the validation step may comprise comparing at least one spectrum obtained from the selected particle to at least one reference spectrum. This reference spectrum may comprise the particle of interest or an excipient or other substance in the sample. This reference spectrum may be one of many reference spectra in a reference database which can be searched depending on the particular particle of interest, excipient, or other substance. The database may comprise more than one reference spectra of one particular particle. It may also comprise two or more reference spectra corresponding to two or more different particles of interest, excipient, or other substance.

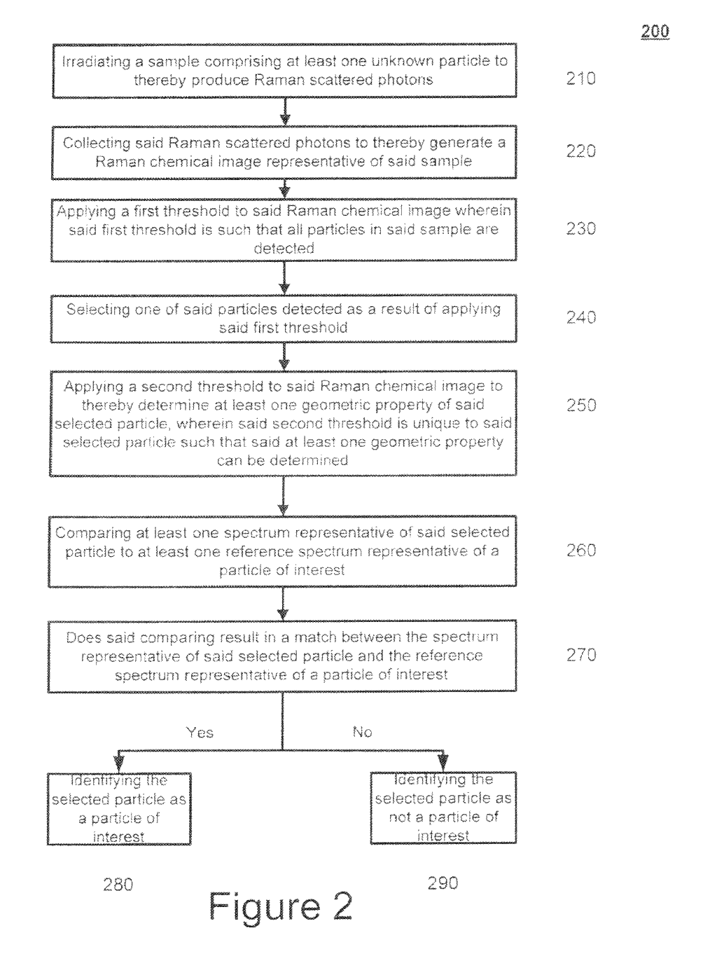

FIG. 2 illustrates one embodiment of the present disclosure in which a reference spectrum is used in the validation step. The method 200 comprises illuminating a sample comprising at least one unknown particle to thereby produce Raman scattered photons in step 210. These photons are collected in step 220 to thereby generate a Raman chemical image representative of said sample. In step 230, a first threshold is applied to said Raman chemical image wherein said first threshold is such that all particles in said sample are detected. One of said particles detected as a result of applying said first threshold is selected in step 240. In step 250 a second threshold is applied to said Raman chemical image to thereby determine at least one geometric property of said selected particle, wherein said second threshold is unique to said selected particle such that that said at least one geometric property can be determined. In step 260, at least one spectrum representative of said selected particle is compared to a reference spectrum representative of a particle of interest. This comparison is performed to determine whether or not there is a match between the spectrum representative of the selected particle and the reference spectrum representative of the particle of interest 270. If there is a match, the selected particle is identified as a particle of interest 280. If there is not a match, the selected particle is rejected as not a particle of interest 290.

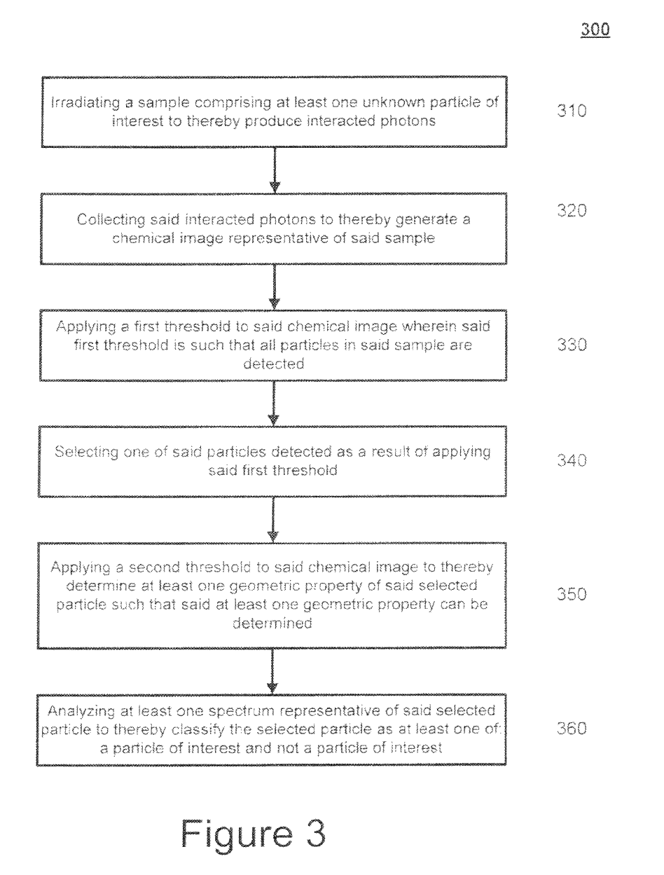

In another embodiment, illustrated by FIG. 3, the method 300 comprises irradiating a sample comprising at least one unknown particle of interest to thereby produce interacted photons in step 310. In one embodiment, these interacted photons are selected from the group consisting of: photons scattered by said sample, photons reflected by said sample, photons absorbed by said sample, photons emitted by said sample, and combinations thereof. In step 320, the photons are collected to thereby generate a chemical image representative of the sample. In step 330, a first threshold is applied to the spectroscopic image wherein said first threshold is such that all particles in said sample are detected. One of said particles detected as a result of the first threshold is selected in step 340. A second threshold is applied in step 350 to thereby determine at least one geometric property of the selected particle wherein the second threshold is unique to said second threshold such that a geometric property can be determined. In step 360 at least one spectrum representative of the selected particle is analyzed to thereby classify the selected particle as at least one of: a particle of interest or not a particle of interest.

In one embodiment, the method may further comprise repeating the steps enumerated herein for one other unknown particle present in said sample. The steps may also be repeated for each unknown particle detected in said sample.

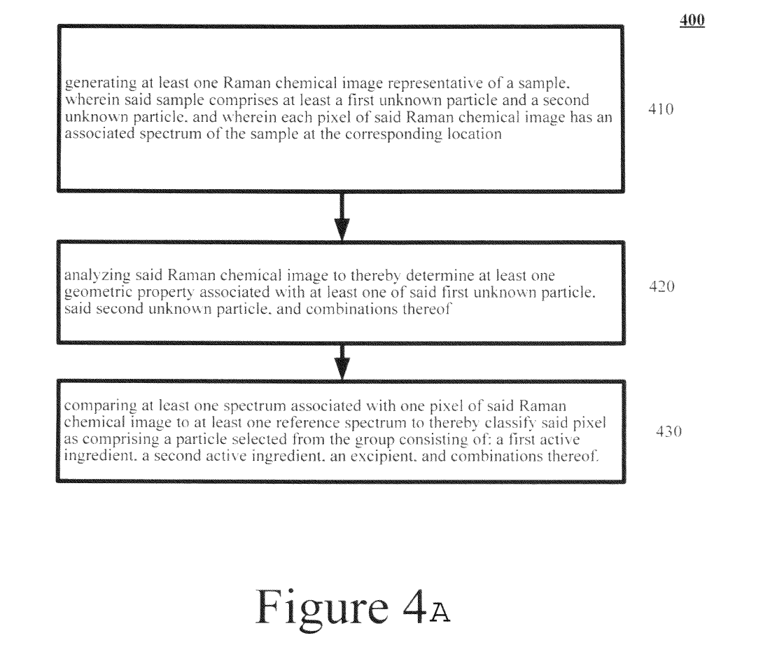

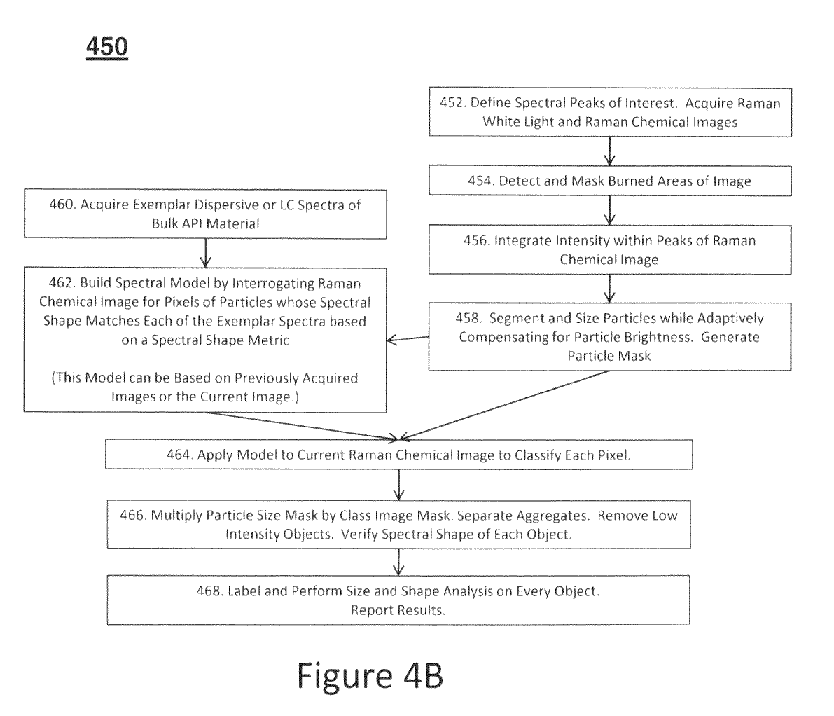

The present disclosure provides for a system and method for detecting, sizing, and classifying a plurality of particles present in a sample. In one embodiment, the present disclosure provides for a method, illustrated by FIG. 4A. In this embodiment, the method 400 may comprise generating at least one Raman chemical image representative of a sample, in step 400. In one, embodiment, a Raman chemical image may be generated by illuminating a sample to thereby generate a first plurality of interacted photons. In one embodiment, this first plurality of interacted photons may be selected from the group consisting of: photons reflected by a sample, photons absorbed by a sample, photons scattered by a sample, photons emitted by a sample, and combinations thereof. In one embodiment, this illumination may comprise wide-field illumination. This first plurality of interacted photons may be sequentially filtered to thereby separate said plurality of interacted photons into a plurality of predetermined wavelength bands. In one embodiment, this filtering may be achieved by implementing a tunable filter as discussed herein.

Each pixel of a Raman chemical image may have an associated spectrum of said sample at the corresponding location. In one embodiment, the sample may comprise a plurality of unknown particles. In one embodiment, a sample may comprise at least a first unknown particle and a second unknown particle. In one embodiment, a Raman chemical image may comprise a Raman hypercube representative of said sample.

In step 420 a Raman chemical image may be analyzed to thereby determine at least one geometric property associated with at least one of said first unknown particle, said second unknown particle, and combinations thereof. In one embodiment, a geometric property may be selected from the group consisting of: an area, a perimeter, a feret diameter, a maximum chord length, a shape factor, an aspect ratio, and combinations thereof. In step 430 at least one spectrum associated with at least one pixel of a Raman chemical image may be compared with a reference spectrum to thereby classify said pixel as comprising a particle selected from the group consisting of: a first active pharmaceutical ingredient of interest, a second active pharmaceutical ingredient of interest, an excipient, and combinations thereof.

In one embodiment, this comparison may be achieved by applying at least one chemometric technique. In one embodiment, a chemometric technique may be selected from the group consisting of: principle component analysis, linear discriminant analysis, partial least squares discriminant analysis, maximum noise fraction, blind source separation, band target entropy minimization, cosine correlation analysis, classical least squares, cluster size insensitive fuzzy-c mean, directed agglomeration clustering, direct classical least squares, fuzzy-c mean, fast non negative least squares, independent component analysis, iterative target transformation factor analysis, k-means, key-set factor analysis, multivariate curve resolution alternating least squares, multilayer feed forward artificial neural network, multilayer perception-artificial neural network, positive matrix factorization, self modeling curve resolution, support vector machine, window evolving factor analysis, and orthogonal projection analysis.

In one embodiment, the method 400 may further comprise applying a first threshold to a Raman chemical image. This first threshold may be such that each particle associated with an active pharmaceutical ingredient of interest is detected. In one embodiment, the method 400 may further comprise applying a second threshold to a Raman chemical image. This second threshold may be adaptive as disclosed herein.

The method 400 may further comprise classifying each pixel in a Raman chemical image as comprising a particle selected from the group consisting of: a first active ingredient of interest, a second active ingredient of interest, an excipient, and combinations thereof.

In one embodiment, the method 400 may further comprise generating a classification mask image and a particle size mask image. These mask images may be multiplied to generate a particle classification image. In one embodiment, a particle classification image may be fused with a Raman white light image representative of a sample.

FIG. 4B is illustrative of a method of the present disclosure. In one embodiment, the method 450 may comprise defining spectral peaks of interest in step 452 and acquiring Raman chemical and Raman white light images. In step 454 burned areas of an image may be detected and masked. In step 456, the intensity within peaks of a Raman chemical image may be integrated. In step 458, particles may be segmented and sized while adaptively compensating for particle brightness. A particle mask may also be generated.

In step 462 a spectral model may be built by interrogating a Raman chemical image for pixels of particles whose spectral shape matches each of the exemplar spectra based on a spectral Shape metric. Exemplar dispersive spectra or LC spectra of bulk API material may be acquired in step 460. A model may be applied to current Raman chemical images to classify each pixel in step 464. A particle size mask may be multiplied by a class image mask, aggregates may be separated, and low intensity objects removed in step 466. Spectral shapes of each object may also be verified in step 466.

In one embodiment, a method of the present disclosure may be automated via software. The present disclosure also provides for a storage medium, containing machine readable program code, which when executed by a processor, causes said processor to perform a method of the present disclosure. In one embodiment, when executed by a processor, the processor may perform the following: generate at least one Raman chemical image representative of a sample, wherein said sample comprises at least a first unknown particle and a second known particle, and wherein each pixel of said Raman chemical image has an associated spectrum of said sample at the corresponding location; analyze said Raman chemical image to thereby determine at least one geometric property associated with at least one of said first unknown particle, said second unknown particle, and combinations thereof; and compare at least one spectrum associated with one pixel of said Raman chemical image to at least one reference spectrum to thereby classify said pixel as comprising a particle selected from the group consisting of: a first active pharmaceutical ingredient of interest, a second active pharmaceutical ingredient of interest, an excipient, and combinations thereof.

In one embodiment a geometric property may be selected from the group consisting of: an area, a perimeter, a feret diameter, a maximum chord length, a shape factor, an aspect ratio, and combinations thereof.

In another embodiment, the storage medium, when executed by a processor to analyze said Raman chemical image may further cause said processor to apply a first threshold to said Raman chemical image, wherein said first threshold is such that each particle associated with an active pharmaceutical ingredient of interest in said sample is detected. In one embodiment, the storage medium when executed by a processor to analyze said Raman chemical image, may further cause said processor to apply a second threshold to said Raman chemical image, wherein said second threshold adaptive. The storage medium when executed by a processor may further cause said processor to classify each pixel in said Raman chemical image as comprising a particle selected from the group consisting of: a first active pharmaceutical ingredient of interest, a second active pharmaceutical ingredient of interest, a non-active pharmaceutical ingredient, and combinations thereof.

In another embodiment, the method disclosed herein may further comprise fusing a Raman chemical image of a sample with a bright field image of said sample to thereby generate a fused image. This fused image can then be analyzed to determine at least one geometric property of at least one unknown particle in a sample.

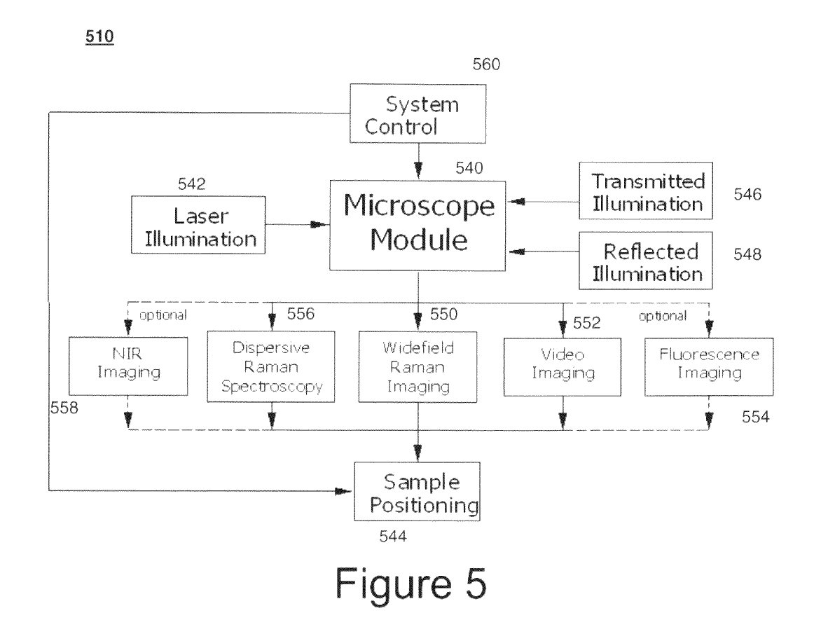

FIG. 5 is a schematic representation of one system that may be used to perform the method of the present disclosure. In one embodiment, this system may comprise FALCON II technology available from ChemImage Corporation, Pittsburgh, Pa. In one embodiment, ChemImage Xpert software, available from ChemImage Corporation, Pittsburgh, Pa. may be used to analyzing image data. In one embodiment, the spectroscopy module 510 may include a microscope module 540 containing optics for microscope applications. An illumination source 542 (e.g., a laser illumination source) may provide illuminating photons to a sample (not shown) handled by a sample positioning unit 544 via the microscope module 540. In one embodiment, photons transmitted, reflected, emitted, or scattered from the illuminated sample (not shown) may pass through the microscope module (as illustrated by exemplary blocks 546, 548 in FIG. 5) before being directed to one or more of spectroscopy or imaging optics in the spectroscopy module 510. The system of FIG. 5 may be configured so as to generate at least one test Raman data set representative of a sample under analysis. In the embodiment of FIG. 5, dispersive Raman spectroscopy 556, widefield Raman imaging 550 and video imaging 552 are illustrated as standard. In other embodiments, the modes of NIR imaging 558 and fluorescence imaging 554 may also be implemented.

The spectroscopy module 510 may also include a control unit 560 to control operational aspects (e.g., focusing, sample placement, laser beam transmission, etc.) of various system components including, for example, the microscope module 540 and the sample positioning unit 544 as illustrated in FIG. 5. In one embodiment, operation of various components (including the control unit 560) in the spectroscopy module 510 may be fully automated or partially automated, under user control.

It is noted here that in the discussion herein the terms “illumination,” “illuminating,” “irradiation,” and “excitation” are used interchangeably as can be evident from the context. For example, the terms “illumination source,” “light source,” and “excitation source” are used interchangeably. Similarly, the terms “illuminating photons” and “excitation photons” are also used interchangeably. Furthermore, although the discussion hereinbelow focuses more on Raman spectroscopy and imaging, various methodologies discussed herein may be adapted to be used in conjunction with other types of spectroscopy applications as can be evident to one skilled in the art based on the discussion provided herein.

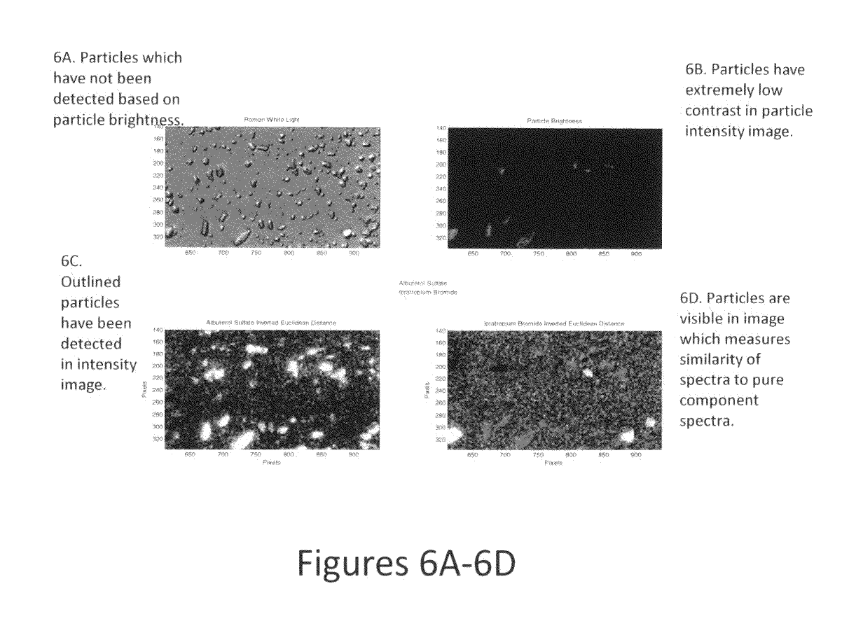

FIGS. 6A-6D are illustrative of an example of how similarity in the shape of spectra of neighboring pixels coupled with similarity to a pure component API spectra can be used to detect API particles. Spectral domain comparison of spectra with pure component spectra was originally intended to classify pixels which were identified based on measure particle intensity. Even if a particle is not bright enough to be detected the ensemble of hyperspectral pixels comprising the particle all have similarly shaped spectra with little randomness in their shapes, and which are similar to one of the pure component spectra. Regions wherein particles are not located have pixel spectra which are random in shape. Shape similarity can be measured using Euclidean distance, cosine correlation, or some or the metric to provide a measure of similarity at every pixel resulting in a spectral shape similarity image. The shape similarity image can be processed to detect particles using the same methods used to detect particles in an intensity image. This method may let us detect, count, and size previously undetected objects.

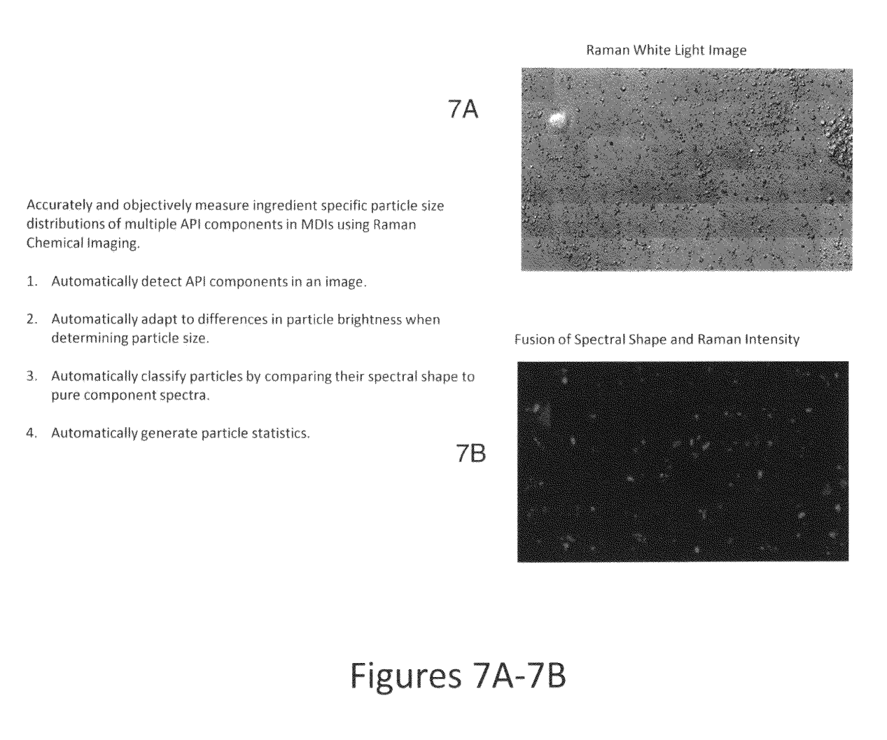

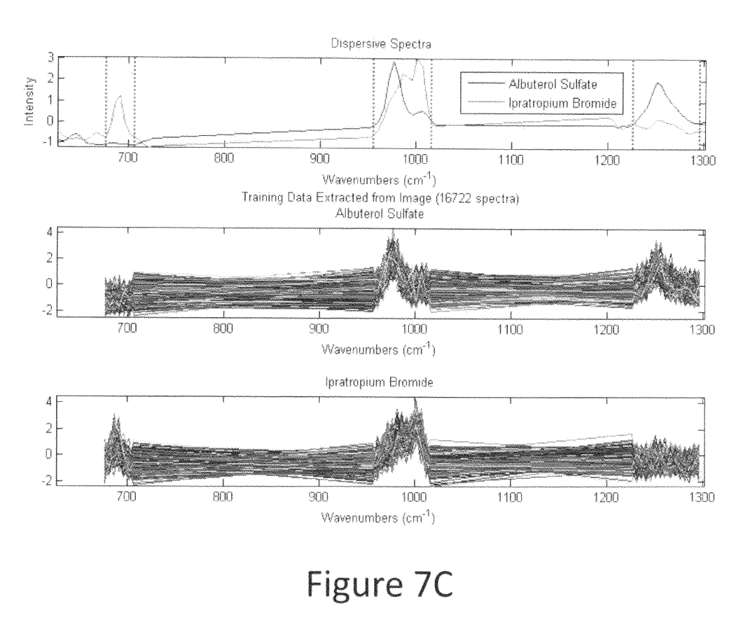

In one embodiment, the present disclosure provides for the automated detection of particles and sizing of multi-component MDIs (metered-dose inhalers). Such an embodiment is represented by FIGS. 7A-7C. In the embodiment, distributions of multiple API components in MDIs are accurately and objectively measured using Raman chemical imaging. In one embodiment, this may be achieved by: (1) automatically detecting API component in an image, (2) automatically adapting to differences in particle brightness when determining particle size, (3) automatically classify particles by comparing their spectral shape to pure component spectra, and (4) automatically generating particle statistics.

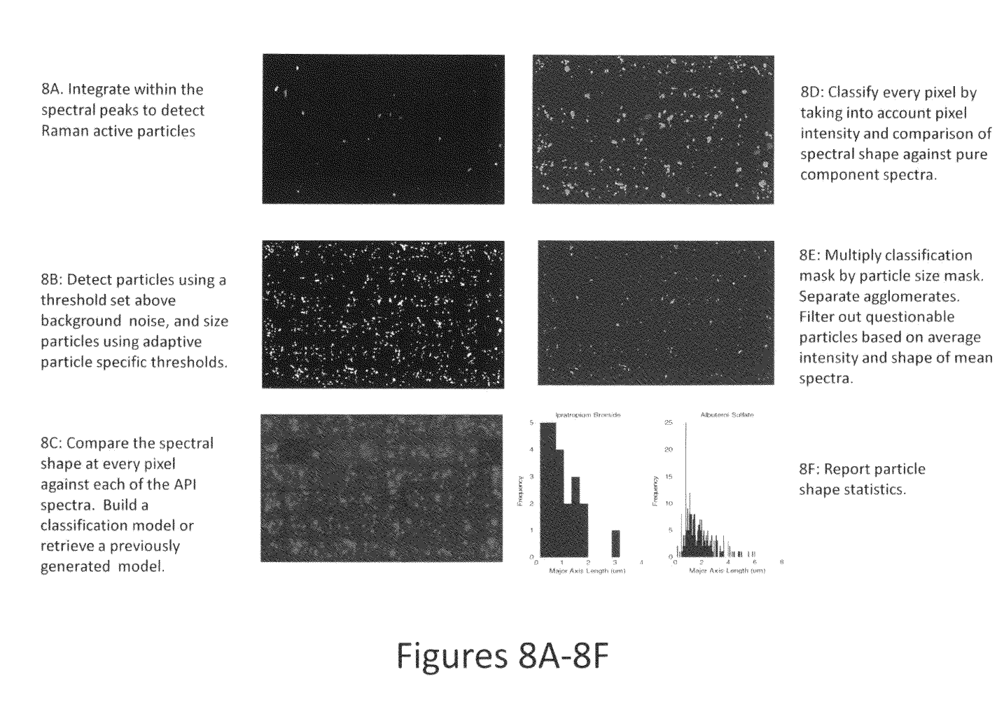

FIGS. 8A-8F are illustrative of a method of the present disclosure. In FIG. 8A, integration within the spectral peaks is performed to detect Raman active particles. In FIG. 8B, particles are detected using a threshold set above background noise, and size particles using adaptive particle specific thresholds. In FIG. 8C, the spectral shape is compared at each pixel against each of the API spectra. A classification model is built or previously generated model is retrieved. In FIG. 8D, every pixel is classified by taking into account pixel intensity and comparison of spectral shape against pure component spectra. In FIG. 8E, the classification mask is multiplied by the particle mask. Agglomerates are separated and questionable particles are filtered out based on average intensity and the shape of the means spectra. In FIG. 8F, particle shape statistics are reported.

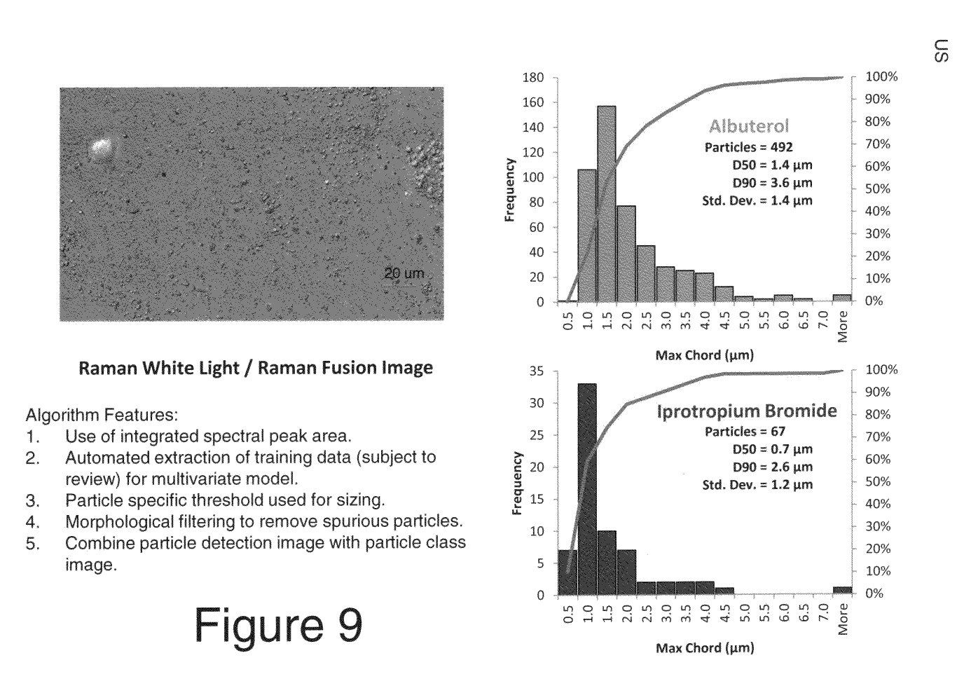

FIG. 9 is illustrative of the ability of the system and method of the present disclosure to detect two or more particles of interest in a sample. As can be seen in the Raman white light/Raman fusion image, the albuterol is labeled green and the iprotropium bromide is labeled blue. Some features of a method of such an embodiment may comprise: using integrated spectral peak area; automated extraction of training data for multivariate model; particle specific threshold used for sizing; morphological filtering to remove spurious particles; and combining particle detection image with particle class image. The histograms provided illustrate the particle sizes, frequency, and percentages.

The present disclosure provides for a system and method for the detection of two or more particles in spectral domain.

Although the present disclosure teaches the detection of two or more particles, it is not limited to such an embodiment. The system and method disclosed herein may also be applied to the detection of one particle.

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the embodiments of the disclosure, it is noted that other variations and modification will be apparent to those skilled in the art, and may be made without departing from the spirit of the disclosure.

What is claimed is:

1. A method comprising:
generating at least one Raman chemical image representative of a sample, wherein
said sample comprises at least a first unknown particle and a second unknown particle, and
wherein each pixel of said Raman chemical image has an associated spectrum of the sample at the corresponding location;
analyzing said Raman chemical image to thereby determine at least one geometric property associated with at least one of said first unknown particle, said second unknown particle, and combinations thereof; and
comparing at least one spectrum associated with one pixel of said Raman chemical image to at least one reference spectrum to thereby classify said pixel as comprising a particle selected from the group consisting of: a first active pharmaceutical ingredient of interest, a second active pharmaceutical ingredient of interest, a non-active pharmaceutical ingredient, and combinations thereof.

2. The method of claim 1 wherein analyzing said Raman chemical image further comprises:
applying a first threshold to said Raman chemical image, wherein said first threshold is such that each particle associated with an active pharmaceutical ingredient of interest in said sample is detected; and
applying a second threshold to said Raman chemical image, wherein said second threshold is such that each particle associated with a first active ingredient of interest is detected.

3. The method of claim 2 further comprising applying a third threshold to said Raman chemical image, wherein said third threshold is such that each particle associated with a second active ingredient of interest is detected.

4. The method of claim 2 wherein said applying of said second threshold is adaptive.

5. The method of claim 3 wherein said applying of said third threshold is adaptive.

6. The method of claim 1 further comprising classifying each pixel in said Raman chemical image as comprising a particle selected from the group consisting of: a first active pharmaceutical ingredient of interest, a second active pharmaceutical ingredient of interest, a non-active pharmaceutical ingredient, and combinations thereof.

7. The method of claim 1 further comprising generating a classification mask image and a particle size mask image.

8. The method of claim 7 further comprising multiplying said classification mask image by said particle size mask image.

9. The method of claim 1 wherein generating said Raman chemical image further comprises:
illuminating said sample to thereby generate a first plurality of interacted photons, wherein said first plurality of interacted photons are selected from the group consisting of: photons reflected by said sample, photons absorbed by said sample, photons emitted by said sample, photons scattered by said sample, and combinations thereof;
filtering said first plurality of interacted photons into a plurality of predetermined wavelength bands; and
detecting said first plurality of interacted photons to thereby generate said Raman chemical image.

10. The method of claim 9 wherein said illuminating comprises wide-field illumination.

11. The method of claim 1 further comprising generating a Raman white light image representative of said sample.

12. The method of claim 11 further comprising fusing said Raman white light image and said Raman chemical image.

13. The method of claim 1 wherein said comparing is achieved by applying at least one chemometric technique.

14. The method of claim 13 wherein said chemometric technique is selected from the group consisting of: principle component analysis, linear discriminant analysis, partial least squares discriminant analysis, maximum noise fraction, blind source separation, band target entropy minimization, cosine correlation analysis, classical least squares, cluster size insensitive fuzzy-c mean, directed agglomeration clustering, direct classical least squares, fuzzy-c mean, fast non negative least squares, independent component analysis, iterative target transformation factor analysis, k-means, key-set factor analysis, multivariate curve resolution alternating least squares, multilayer feed forward artificial neural network, multilayer perception-artificial neural network, positive matrix factorization, self modeling curve resolution, support vector machine, window evolving factor analysis, and orthogonal projection analysis.

15. The method of claim 1 wherein generating said Raman chemical image further comprises generating a Raman hypercube representative of said sample.

16. The method of claim 1 wherein said method is automated via software.

17. The method of claim 1 wherein said geometric property is selected from the group consisting of: an area, a perimeter, a feret diameter, a maximum chord length, a shape factor, an aspect ratio, and combinations thereof.

18. A storage medium containing machine readable program code, which, when executed by a processor, causes said processor to perform the following:
generate at least one Raman chemical image representative of a sample, wherein
said sample comprises at least a first unknown particle and a second unknown particle, and
wherein each pixel of said Raman chemical image has an associated spectrum of the sample at the corresponding location;
analyze said Raman chemical image to thereby determine at least one geometric property associated with at least one of said first unknown particle, said second unknown particle, and combinations thereof; and
compare at least one spectrum associated with one pixel of said Raman chemical image to at least one reference spectrum to thereby classify said pixel as comprising a particle selected from the group consisting of: a first active pharmaceutical ingredient of interest, a second active pharmaceutical ingredient of interest, a non-active pharmaceutical ingredient, and combinations thereof.

19. The storage medium of claim 18 which when executed by a processor to analyze said Raman chemical image, further causes said processor to:
apply a first threshold to said Raman chemical image, wherein said first threshold is such that each particle associated with an active pharmaceutical ingredient of interest in said sample is detected.

20. The storage medium of claim 19 which when executed by a processor to analyze said Raman chemical image, further causes said processor to:
apply a second threshold to said Raman chemical image, wherein said second threshold adaptive.

21. The storage medium of claim 18 which when executed by a processor further causes said processor to classify each pixel in said Raman chemical image as comprising a particle selected from the group consisting of: a first active pharmaceutical ingredient of interest, a second active pharmaceutical ingredient of interest, a non-active pharmaceutical ingredient, and combinations thereof.

22. The storage medium of claim 18 wherein said geometric property is selected from the group consisting of: an area, a perimeter, a feret diameter, a maximum chord length, a shape factor, an aspect ratio, and combinations thereof.

23. A system comprising:
an illumination source configured so as to illuminate a sample to thereby generate a first plurality of interacted photons, wherein said sample comprises at least a first unknown particle and a second unknown particle;
a tunable filter configured so as to sequentially filter said first plurality of interacted photons;
a detector configured so as to detect said first plurality of interacted photons and generate at least one Raman chemical image representative of said sample, wherein each pixel of said Raman chemical image has an associated spectrum of the sample at the corresponding location;
a means for analyzing said Raman chemical image to thereby determine at least one geometric property of at least one of said first unknown particle, said second unknown particle, and combinations thereof;
a means for comparing at least one spectrum associated with at least one pixel of said Raman chemical image to at least one reference spectrum to thereby classify said pixel as comprising a particle selected from the group consisting of: a first active pharmaceutical ingredient of interest, a second active pharmaceutical ingredient of interest, a non-active pharmaceutical ingredient, and combinations thereof.

24. The system of claim 23 wherein said tunable filter is selected from the group consisting of: a liquid crystal tunable filter, a multi-conjugate liquid crystal tunable filter, an acousto-optical tunable filter, a Lyot liquid crystal tunable filter, an Evans split-element liquid crystal tunable filter, a Solc liquid crystal tunable filter, a ferroelectric liquid.

25. The system of claim 23 further comprising a display configured so as to display a result of said pixel classification.
